(19) United States
(12) Patent Application Publication
(10) Pub. No.: US 2012/0296469 A1
(43) Pub. Date: Nov. 22, 2012

(54) SUCKING-CONVEYING DEVICE HAVING VISION SENSOR AND SUCTION UNIT

(75) Inventors: Toshimichi Yoshinaga, Minamitsuru-gun (JP); Masaru Oda, Minamitsuru-gun (JP); Keisuke Suga, Minamitsuru-gun (JP)

(73) Assignee: FANUC Corporation, Minamitsuru-gun (JP)

(21) Appl. No.: 13/419,462

(22) Filed: Mar. 14, 2012

(30) Foreign Application Priority Data
May 20, 2011 (JP) 2011-113770

(51) Int. Cl. G06F 7/00

(52) U.S. Cl. 700/218; 901/40; 901/47

(57) ABSTRACT

A sucking-conveying device capable of sequentially and efficiently taking out and conveying a workpiece one-by-one, even when a taking-out means attached to the robot is not correctly positioned relative to a workpiece to be taken out. The sucking-conveying device includes a robot and a vision sensor capable of detecting a plurality of workpieces randomly located in a container. A suction nozzle, configured to suck and take out the workpieces one-by-one, is mounted on the robot. By attaching the nozzle to a robot arm, the position and orientation of the nozzle may be changed. The suction nozzle is fluidly connected to a suction unit via a blow member. The suction unit sucks air through the nozzle, and generates suction force at the nozzle for sucking a target workpiece to be taken out toward the nozzle, whereby the nozzle can suck and hold the target workpiece.

### BACKGROUND OF THE INVENTION

1. Field of the Invention

The present invention relates to a sucking-conveying device for taking out randomly piled workpieces, by means of a robot having a vision sensor and a suction unit.

2. Description of the Related Art

A device using a robot, for sequentially taking out a plurality of workpieces, which are randomly piled on a pallet or in a box, is known. For example, Japanese Unexamined Patent Publication (Kokai) No. 2010-12567 discloses an article taking out device configured to grip and taking out a workpiece in a container, by using a robot having an electromagnet, a suction pad or a chuck mechanism attached to a front end of the robot.

In the invention of Japanese Unexamined Patent Publication (Kokai) No. 2010-12567, a robot hand cannot effectively take out a workpiece in some cases. For example, the robot hand may interfere with another workpiece near a workpiece to be taken out, and/or the robot hand cannot move to the appropriate position or orientation relative to the workpiece to be taken out, due to a positional detection error of a camera. Further, when a robot hand having a magnet force is used, the robot hand may simultaneously adsorb and hold a plurality workpiece, and it is difficult to take out the workpieces one-by-one.

### SUMMARY OF THE INVENTION

An object of the present invention is to provide a sucking-conveying device capable of sequentially and efficiently taking out and conveying a workpiece one-by-one, even when a taking-out means attached to the robot is not correctly positioned relative to a workpieces to be taken out.

According to the present invention, a sucking-conveying device configured to suck and take out a target which is one of a plurality of randomly located workpieces, by using a suction nozzle mounted on a robot is provided, the device comprising: a vision sensor having a camera configured to capture a two-dimensional image of the plurality of randomly located workpieces, and an image processor configured to process the image captured by the camera, wherein the vision sensor selects a target to be taken out based on the captured two-dimensional image, calculates a two-dimensional position of the target, and calculates a view line of the camera in a three-dimensional space extending between the target and the camera based on the two-dimensional position of the target; a suction unit fluidly connected to the suction nozzle, wherein the suction unit sucks air through the suction nozzle and generates suction force at the suction nozzle for sucking the target toward the suction nozzle; and a contact detecting part which detects that the suction nozzle comes into contact with the target, wherein the robot conducts an approach motion in which the suction nozzle approaches the target along the calculated view line of the camera, wherein the approach motion is stopped when the contact detecting part detects that the suction nozzle comes into contact with the target during the approach motion, and wherein the orientation of the target relative to the suction nozzle is corrected, due to the suction force of the suction unit, from a contact orientation in which the target contacts the suction nozzle to a suction-hold orientation in which the target is sucked and held by the suction nozzle.

In a preferred embodiment, the contact detecting part is a unit which monitors feedback information of a servo of the robot and detects a change of the feedback information due to the contact between the target and the suction nozzle, in order to detect that the suction nozzle comes into contact with the target.

Otherwise, the contact detecting part may be a telescopic floating mechanism arranged between the suction nozzle and a movable part of the robot, the floating mechanism being configured to contract when the nozzle comes into contact with the target.

A limiting member may be arranged at the suction nozzle, the limiting member being configured to limit a volume of a part of the target which is contained within the suction nozzle.

The sucking-conveying device of the invention may comprise a suction detecting part which detects that the target is held by the suction nozzle.

For example, the suction detecting part is a suction detecting sensor which detects at least one of an air pressure, an air mass flow and a velocity of air flow between the suction nozzle and the suction unit.

In a preferred embodiment, a size of an opening of the suction nozzle is smaller than a size of a sucked portion of the target so that the number of the targets taken out in one taking-out operation is limited to one.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is a perspective view of a sucking-conveying device according to an embodiment of the present invention;

FIG. 2 is a flowchart indicating a take out process of a workpiece using the sucking-conveying device according to the embodiment of the invention;

FIG. 3 shows a state wherein the workpiece is captured by a camera;

FIG. 4 shows a state wherein a suction nozzle is positioned at an approach position;

FIG. 5 shows a state wherein the suction nozzle comes into contact with a target workpiece to be taken out;

FIG. 6 shows a state wherein the orientation of the target workpiece is corrected due to suction force by the suction nozzle, and the target workpiece is sucked and held by the suction nozzle;

FIG. 7 shows a state wherein the target workpiece sucked and held by the nozzle is detected by a second camera; and

FIG. 8 shows a state wherein the target workpiece sucked and held by the nozzle is located on a temporary location table.

### DETAILED DESCRIPTION

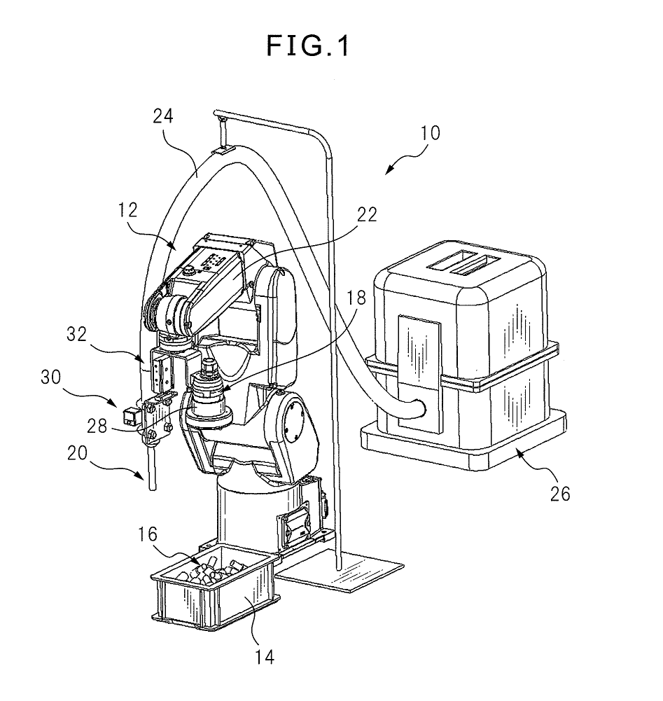

FIG. 1 is an external view showing a schematic configuration of a sucking-conveying device 10 according to the present invention. Sucking-conveying device 10 includes a robot 12 and a vision sensor 18 capable of detecting a plurality of (in the drawings, same kinds of) workpieces 16 which are randomly located at a predetermined place, such as a container 14. A suction nozzle 20 is mounted on robot 12, and suction nozzle 20 is configured to suck and take out workpieces 16 one-by-one. Concretely, suction nozzle 20 is attached to a front end of a robot arm 22 (for example, a six-axes robot arm) configured to move about each axis. By attaching suction nozzle 20 to robot arm 22, the position and orientation of the nozzle may be changed. Suction nozzle 20 is fluidly connected to a suction unit 26 via a blow member 24 such as a pipe, a tube and/or a duct. Suction unit 26 sucks air through suction nozzle 20, and generates suction force at suction nozzle 20 for sucking a target workpiece to be taken out (as explained below) toward suction nozzle 20, whereby suction nozzle 20 can suck and hold the target workpiece. As suction unit 26, a unit, capable of generating an air flow having a mass flow or a velocity required to suck and hold the workpiece by means of the suction nozzle, is selected.

Vision sensor 18 has a camera 28 attached to a movable part (in the drawing, a front end of robot arm 22) and configured to capture a two-dimensional image of at least one (preferably, the entirety) of workpieces 16 which are randomly located in container 14; and an image processor (not shown) configured to process the two-dimensional image captured by camera 28. The image processor selects one workpiece as a target to be taken out, based on the two-dimensional image captured by camera 28, calculates a two-dimensional position of the target, and calculates a view line of camera 28 in a three-dimensional space extending between the target and camera 28 based on the two-dimensional position of the target. However, camera 28 may be positioned at any place as long as the camera can capture workpiece 16. For example, camera 28 may be positioned at a fixed portion of robot 12, or a place other than robot 12. In addition, although workpieces 16 are randomly located or piled in a box-shaped container 14, the present invention is not limited to such a case. For example, the workpieces may be randomly located on a pallet.

Robot 12 has a suction detecting part which detects that target workpiece 16 is held by suction nozzle 20. In the illustrated embodiment, the suction detecting part is a suction detecting sensor 30 which is configured to detect at least one of an air pressure, an air mass flow and a velocity of air flow within nozzle 20 or between suction nozzle 20 and suction unit 26. When suction nozzle 20 sucks and holds workpiece 16, at least a part of an opening end of suction nozzle 20 is closed by the held workpiece, whereby the air pressure, the air mass flow and the air velocity within suction nozzle 20 are lowered in comparison to a case in which no workpiece is sucked and held by the suction nozzle. By detecting a change of the pressure, the mass flow or the velocity by means of suction detecting sensor 30, it can be judged whether suction nozzle 20 sucks and holds workpiece 16 or not.

Sucking-conveying device 10 has a contact detecting part (In the illustrated embodiment, a contact detecting sensor 32 arranged on suction nozzle 20) which detects that suction nozzle 20 comes into contact with workpiece 16. Contact detecting sensor 32 is a telescopic floating mechanism arranged between suction nozzle 20 and the front end of robot arm 22, the floating mechanism being configured to contract when nozzle 20 comes into contact with an object. By detecting the contraction of the floating mechanism, it can be detected that suction nozzle 20 comes into contact with an article such as workpiece 16.

As the contact detecting part, a unit such as a controller which analyzes feedback of a servo for driving each axis of robot 12 may be used, instead of the above floating mechanism. When suction nozzle 20 contacts the workpiece or the like, the feedback information is changed (for example, a current value of the servo and/or a torque of a motor is increased). Therefore, by monitoring the feedback information of the servo and analyzing a change thereof, it can be detected that suction nozzle 20 comes into contact with an article.

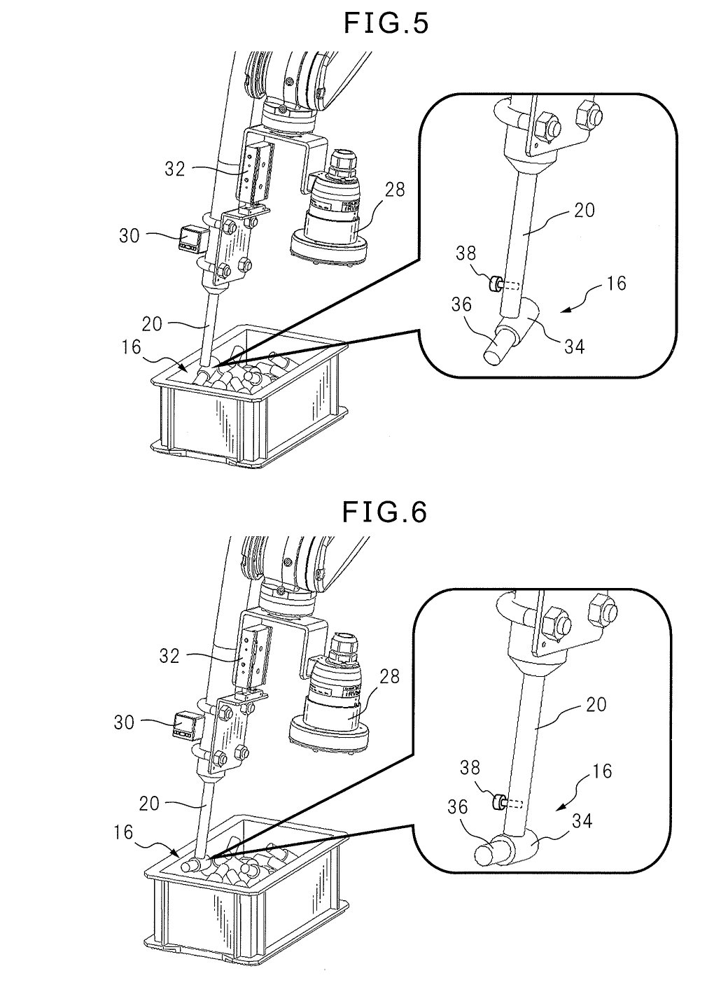

As shown in FIG. 5 explained below, workpiece 16 in the embodiment has a first cylindrical portion 34 having an outer diameter which is larger than an inner diameter of nozzle 20, and a second cylindrical portion 36 having an outer diameter which is smaller than the outer diameter of first cylindrical portion 34, wherein the first and second cylindrical portions are coaxially connected to each other. In the embodiment, a cylindrical surface of first cylindrical portion 34 is to be sucked by nozzle 20 while workpiece 16 is conveyed. As such, when a size of an opening of suction nozzle 20 is smaller than a size of a sucked portion of target workpiece 16, the number of the workpieces taken out in one operation can be limited to one.

However, the conveying pattern of the workpiece in the present invention is not limited to the above. For example, a cylindrical surface of second cylindrical portion 36 of workpiece 16 may be sucked and held, or, an end surface of the first or second cylindrical portion may be sucked and held. Otherwise, when each workpiece has a disc-shape, a portion of a front surface or a back surface of the disc may be sucked and held. As such, the conveying pattern of the workpiece may be determined corresponding to the shape of the workpiece, a place to which the workpiece is conveyed or the content of next process, etc.

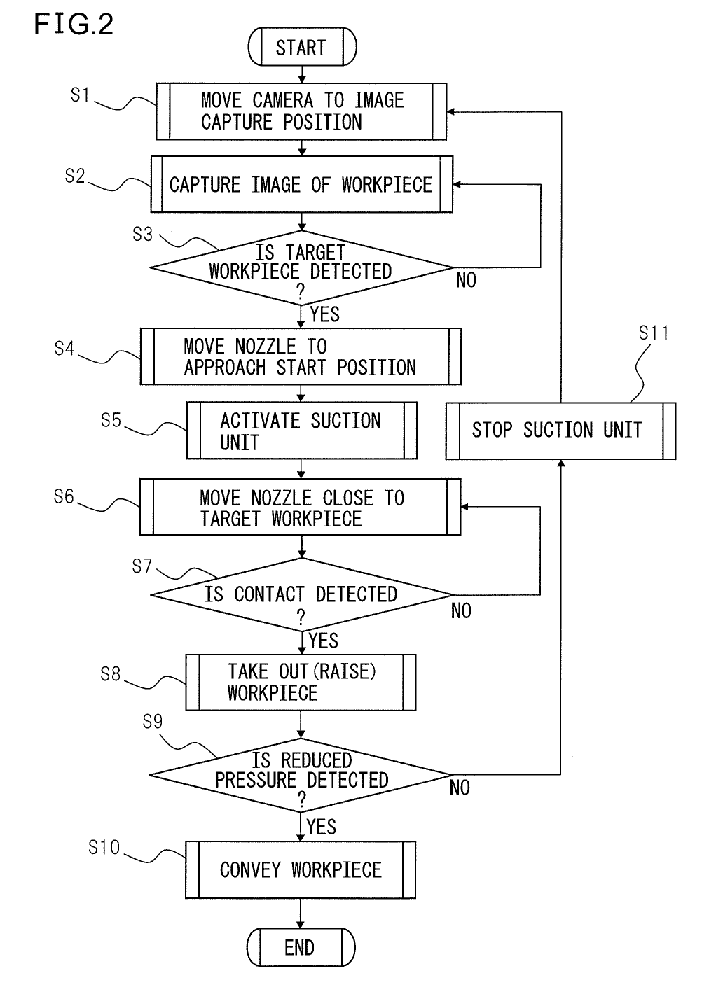

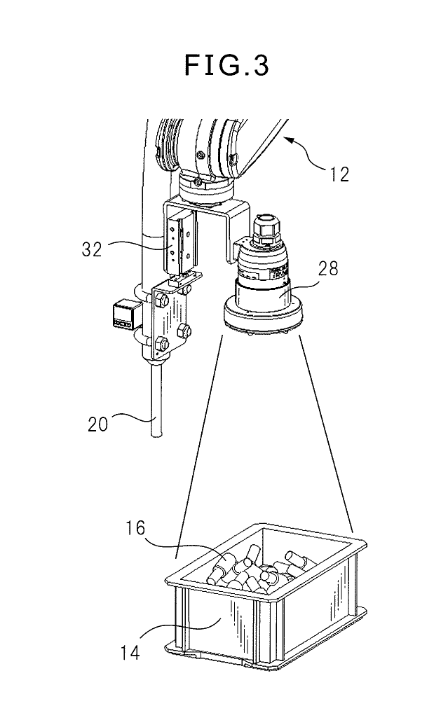

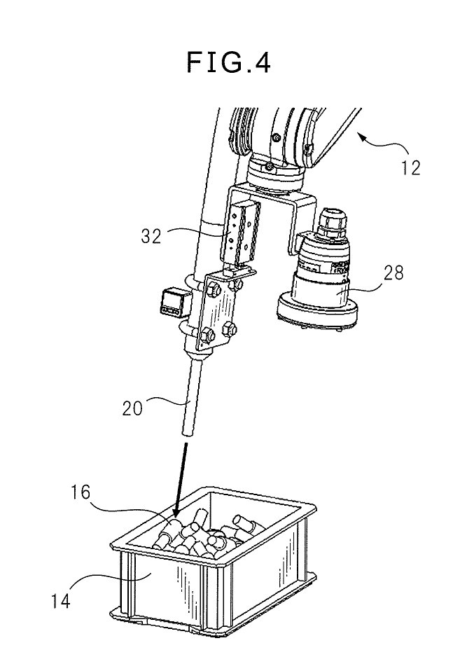

Next, a conveying procedure of workpiece 16 by means of sucking-conveying device 10 is explained with reference to FIGS. 3 to 6 and a flowchart of FIG. 2. First, as shown in FIG. 3, robot 12 is operated and camera 28 is moved to the position where camera 28 can capture an image of workpiece 16 in container 14 (step S1), and then a two-dimensional image of workpiece 16 is obtained by using camera 28 (step S2). Next, the two-dimensional image obtained by camera 28 is processed, and one workpiece 16 is detected or selected as a target to be taken out (step S3). In relation to the detection or selection of the target to be taken out by means of first vision sensor 18, a detailed explanation is omitted since a conventional technique may be used. In one example of the detection, a plurality of workpieces 16 in container 14 are imaged, the obtained image is processed so as to calculate the position and orientation (posture) of each workpiece, and one workpiece is selected so that an amount of change in the position and orientation of suction nozzle 20 is minimized (or a time for changing the position and orientation of the suction nozzle is minimized) when one of the workpieces is sucked. Further, when some workpieces overlap with each other, the upper workpiece may be preferentially taken out.

After a workpiece to be taken out detected (step S3), robot 12 is controlled so that suction nozzle 20 is move to an approach start position (step S4). At the approach start position, suction nozzle 20 is separated from target workpiece 16 by a predetermined distance, and the front end (or an opening for suction) of suction nozzle may firstly contact target workpiece 16 (in detail, a cylindrical surface of first cylindrical portion 34 of target workpiece 16) by moving in a direction of a view line of camera 28. The view line of camera 28 means a view line of camera 28 in a three-dimensional space extending between camera 28 and the two-dimensional position of the target to be taken out selected from the two-dimensional image of workpieces 16 obtained by camera 28.

Next, suction unit 26 as shown in FIG. 1 is activated so that a predetermined suction force can be obtained by sucking air from the front end of suction nozzle 20 (step S5), and nozzle 20 is moved close to (or approaches) target workpiece 16 while sucking air (step S6). In addition, suction unit 26 may be activated immediately before or immediately after the contact between nozzle 20 and target workpiece 16.

The movement of suction nozzle 20 in step S6 is continued until contact detecting unit 32 detect that suction nozzle 20 while moving comes into contact with target workpiece 16 (step S7). As shown in FIG. 5, at a contact orientation of the workpiece, i.e., immediately after the front end of suction nozzle 20 contacts workpiece 16 (in the drawing, the cylindrical surface of first cylindrical portion 34), the orientation of workpiece 16 is not appropriate relative to suction nozzle 20. At this point, since suction unit 26 connected to suction nozzle 20 is in operation, the orientation (or a three-dimensional inclination) of target workpiece 16 is corrected due to suction force generated by suction nozzle 20, and then workpiece 16 is appropriately sucked and held by suction nozzle 20 (i.e., the workpiece represents a suction-hold orientation), as shown in FIG. 6. In other words, in the present invention, once suction nozzle 20 contacts target workpiece 16, the orientation of the target workpiece is automatically changed from the contact orientation to the suction-hold orientation due to the suction force by the suction nozzle. Therefore, in the present invention, it is not necessary to precisely determine or adjust the position and/or orientation of suction nozzle 20 when the suction nozzle approaches the target workpiece.

As shown in FIGS. 5 and 6, suction nozzle 20 may have a limiting member 38 for limiting a volume of a part of target workpiece 16 which is contained within suction nozzle 20. In the drawing, limiting member 38 is a screw or a pin attached to a site of suction nozzle 20 which is separated from the front end of the nozzle by a distance corresponding to an allowable volume of workpiece 16 which may be contained within the suction nozzle. Concretely, limiting member 38 is configured to extend within suction nozzle 20 and limit a movement distance of workpiece 16 within suction nozzle 20 to an allowable value. Instead of the screw or the pin, a mesh may be arranged in suction nozzle 20.

When it is detected that suction nozzle 20 contacts target workpiece 16, suction nozzle 20 is stopped and moved backward (or raised) so that target workpiece 16 is taken out (step S8). At this point, by using suction detection sensor 32, at least one of the air pressure, the air mass flow and the air velocity within suction nozzle 20 is measured, and then it is judged whether suction nozzle 20 holds the workpiece based on the measured value (step S9). In other words, when the air pressure within suction nozzle 20 is lower than a predetermined negative pressure, or when the mass flow or the velocity in nozzle 20 is lower than a predetermined value, target workpiece 16 is properly sucked and held by suction nozzle 20, as shown in FIG. 6. Therefore, robot 12 operated so that the sucked and held workpiece is conveyed to a predetermined conveying place (step S10).

On the other hand, when the air pressure within suction nozzle 20 detected by suction detecting sensor 30 is not lower than the predetermined negative pressure, suction nozzle 20 fails to suck and hold the workpiece (the workpiece is not held by suction nozzle 20). Therefore, suction unit 26 is once stopped (step S11) and the procedure is returned to step S1.

After the taking-out operation and the conveying operation for the workpiece are completed, a new target workpiece is detected, taken out (sucked) and conveyed, according to the flowchart of FIG. 2. In this regard, when the position and orientation of the remaining workpieces are not significantly changed, steps S1 and S2 may be omitted.

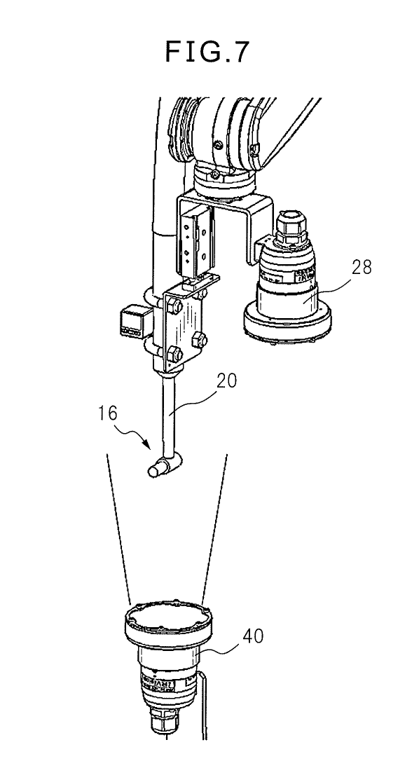

As explained above, in the present invention, by means of the suction nozzle which utilizes the suction force generated by sucking air, the degree of freedom for the position and orientation of the suction nozzle at the time of suctioning the workpiece may be increased. However, the orientation of the held workpiece relative to the suction nozzle may not always be constant in every sucking operation. Then, as shown in FIG. 7, separately from camera 20, a second camera 40 which is arranged at a fixed place, may be used in order to detect the orientation of workpiece 16 which is being held by suction nozzle 20. By virtue of this, the orientation of the workpiece in the next process may be constant in every operation, by, for example, comparing the detected orientation of workpiece 16 held by the suction nozzle with a reference orientation previously measured.

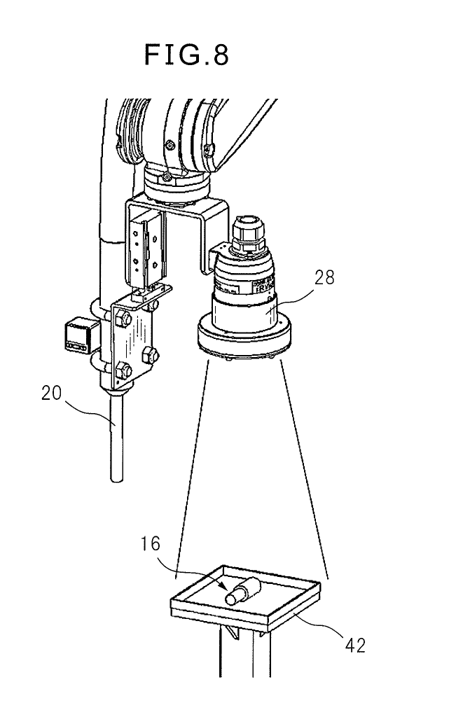

Depending on the detection result of the orientation of workpiece 16 held by suction nozzle 20, it may be necessary to retry the sucking and holding operation for the workpiece. In such a case, as shown in FIG. 8, workpiece 16 taken out by suction nozzle 20 may be located on a temporary location table 42 once, and then workpiece 16 located on table 42 may be detected by camera of the vision sensor. By virtue of this, it is possible to retry the sucking and holding operation for workpiece 16 by means of suction nozzle 20, by utilizing the detection result by the camera.

According to the present invention, since the workpiece can be taken out as long as the front end of the suction nozzle contacts the workpiece, it is not necessary to precisely control the position and orientation of the nozzle relative to the workpiece. Therefore, the difficulty in taking out one workpiece due to the condition or the density of the workpieces may be resolved, and the efficiency of the taking-out operation from the randomly piled workpieces is considerably increased. Further, the influence of the detection accuracy of the vision sensor becomes smaller. In addition, when the shape of the suction nozzle is adapted to take out one workpiece, taking out a plurality of workpieces simultaneously is easily avoided, and the workpiece can be taken out one-by-one.

As the contact detection part, relatively simple means can be used, such as the feedback of the servo or the floating mechanism. When the feedback is used, it is not necessary to arrange a component or a unit, whereby the sucking-conveying device may be compact.

By providing the limiting member to the suction nozzle, it is assuredly avoided that the workpiece is disadvantageously inserted into the suction nozzle.

By arranging the suction detecting part, it is assuredly detected that the target workpiece is sucked and held by the suction nozzle. As the suction detecting part, a sensor, which detects the air pressure, the air mass flow or the velocity of air flow in the suction nozzle, may be used.

When the size of the opening of the suction nozzle is smaller than the size of the sucked site of the target, the number of the taken out target in one taking-out operation is limited to one.

While the invention has been described with reference to specific embodiments chosen for the purpose of illustration, it should be apparent that numerous modifications could be made thereto, by a person skilled in the art, without departing from the basic concept and scope of the invention.

1. A sucking-conveying device configured to suck and take out a target which is one of a plurality of randomly located workpieces, by using a suction nozzle mounted on a robot, the device comprising:
a vision sensor having a camera configured to capture a two-dimensional image of the plurality of randomly located workpieces, and an image processor configured to process the image captured by the camera, wherein the vision sensor selects a target to be taken out based on the captured two-dimensional image, calculates a two-dimensional position of the target, and calculates a view line of the camera in a three-dimensional space extending between the target and the camera based on the two-dimensional position of the target;
a suction unit fluidly connected to the suction nozzle, wherein the suction unit sucks air through the suction nozzle and generates suction force at the suction nozzle for sucking the target toward the suction nozzle; and
a contact detecting part which detects that the suction nozzle comes into contact with the target,
wherein the robot conducts an approach motion in which the suction nozzle approaches the target along the calculated view line of the camera, wherein the approach motion is stopped when the contact detecting part detects that the suction nozzle comes into contact with the target during the approach motion, and wherein the orientation of the target relative to the suction nozzle is corrected, due to the suction force of the suction unit, from a contact orientation in which the target contacts the suction nozzle to a suction-hold orientation in which the target is sucked and held by the suction nozzle.

2. The sucking-conveying device as set forth in claim 1, wherein the contact detecting part is a unit which monitors feedback information of a servo of the robot and detects a change of the feedback information due to the contact between the target and the suction nozzle, in order to detect that the suction nozzle comes into contact with the target.

3. The sucking-conveying device as set forth in claim 1, wherein the contact detecting part is a telescopic floating mechanism arranged between the suction nozzle and a movable part of the robot, the floating mechanism being configured to contract when the nozzle comes into contact with the target.

4. The sucking-conveying device as set forth in claim 1, wherein a limiting member is arranged at the suction nozzle, the limiting member being configured to limit a volume of a part of the target which is contained within the suction nozzle.

5. The sucking-conveying device as set forth in claim 1, wherein the device comprises a suction detecting part which detects that the target is held by the suction nozzle.

6. The sucking-conveying device as set forth in claim 5, wherein the suction detecting part is a suction detecting sensor which detects at least one of an air pressure, an air mass flow and a velocity of air flow between the suction nozzle and the suction unit.

7. The sucking-conveying device as set forth in claim 1, wherein a size of an opening of the suction nozzle is smaller than a size of a sucked portion of the target so that the number of the targets taken out in one taking-out operation is limited to one.
